(19) United States
(12) Patent Application Publication
(10) Pub. No.: US 2013/0121678 A1
(43) Pub. Date: May 16, 2013

(54) METHOD AND AUTOMATED LOCATION INFORMATION INPUT SYSTEM FOR CAMERA

(71) Applicant: Alfred Xueliang Xin, Cincinnati, OH (US)

(72) Inventor: Alfred Xueliang Xin, Cincinnati, OH (US)

(21) Appl. No.: 13/297,332

(22) Filed: Nov. 16, 2011

(51) Int. Cl. G03B 17/24

(52) U.S. Cl. 396/310

(57) ABSTRACT

A method and automated location information input system for camera comprising: a microprocessor is coupled to and receives location information from a GPS (Global Position System), or a GIS (Geographical Information System) via a network and or internet connection; the processor is also coupled to a display device and a photograph imaging device. The microprocessor is capable of displaying location information and processing information edited by a user via the display device with touch screen keyboard or a keyboard, and capable of transferring location information displayed on the display device to the photograph imaging device which is capable of adding location information to photograph images when photographs are taken and stored in a photographic storing medium.

### BACKGROUND OF THE INVENTION

Cameras have function of putting date and time stamps on photographs and may also have functions to add other captions. However after a period of time we may easily forget where the pictures or videos are taken and therefore a great part of value related to where and why the pictures or recordings taken are lost. Though cameras equipped with global position system (GPS) organize picture files with locations marked on a digital map and may allow user to add location related information on pictures taken and it helps to track and memorize where the pictures are taken afterwards, there are many disadvantages of such system that won't be able to overcome.

First such system requires certain reviewing technical means to look at the pictures or watch the video geographically logged on a digital map, without said technical means said logging or positioning system won't be able to function; further such a system requires afterwards extra works to add location information on pictures, especially if location information is needed or preferred on a printed hard copy of photographs, and still further video recordings won't be able to have location caption automatically added on them at their shooting time.

A system is needed to be developed to allow users of cameras, or any electronic devices equipped with cameras such as a cell phone and personal digital assistant (PDA) to automatically obtain location information as they needed before taking pictures or shooting videos, and to be able to add said location information on photographs as when they are taken.

### FIELD OF THE INVENTION

The present invention generally relates to accurately record and display location information on photographs, and more particularly, relates to a method and system for automatically obtaining location information for cameras, and further adding said location information on photographs when they are taken.

### SUMMARY OF THE INVENTION

A method and automated location information input system for camera comprises of a microprocessor is coupled to and capable of receiving location data from a GPS or a GIS (Geographical Information System), such as Google Map, via a wireless network and or Internet; and a visual display means such as a LCD viewfinder of a camera is coupled to said microprocessor and is able to display said location information; said microprocessor is also coupled to photograph imaging means and is able to add said location information on photographs when they are taken and saved in imaging storage means of said camera.

Said location information displayed may be edited via a graphic user interface (GUI) or a keyboard, and said location information is subsequently digitally added on digital photographs as they are taken and stored on a digital memory medium, or exposed to film photographs as they are taken by a photographic imprint projection device.

Said location information received from said a GPS or a GIS via a wireless network and or Internet, by said microprocessor continues to update, and subsequently update location information displayed on said display means of a camera and simultaneously available for said photographs imaging means.

Said system may process and function with different languages. Said system may be activated or cancelled by either physically selecting a menu option or by using a verbal command to instruct a voice recognition command system.

BRIEF DESCRIPTIONS OF DRAWINGS The advantages of the present invention and objects may be best understood by the following detailed description of the preferred embodiments illustrated in the drawings wherein:

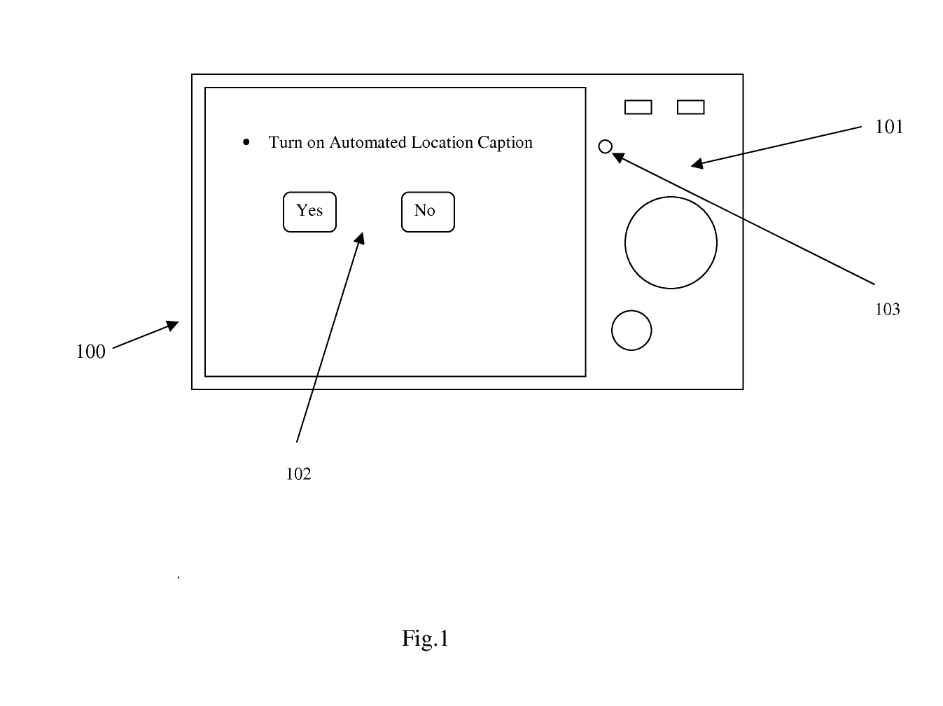

FIG. 1: Drawing to show an automated location information input system for camera is coupled to a camera turned on and ready to activate said system.

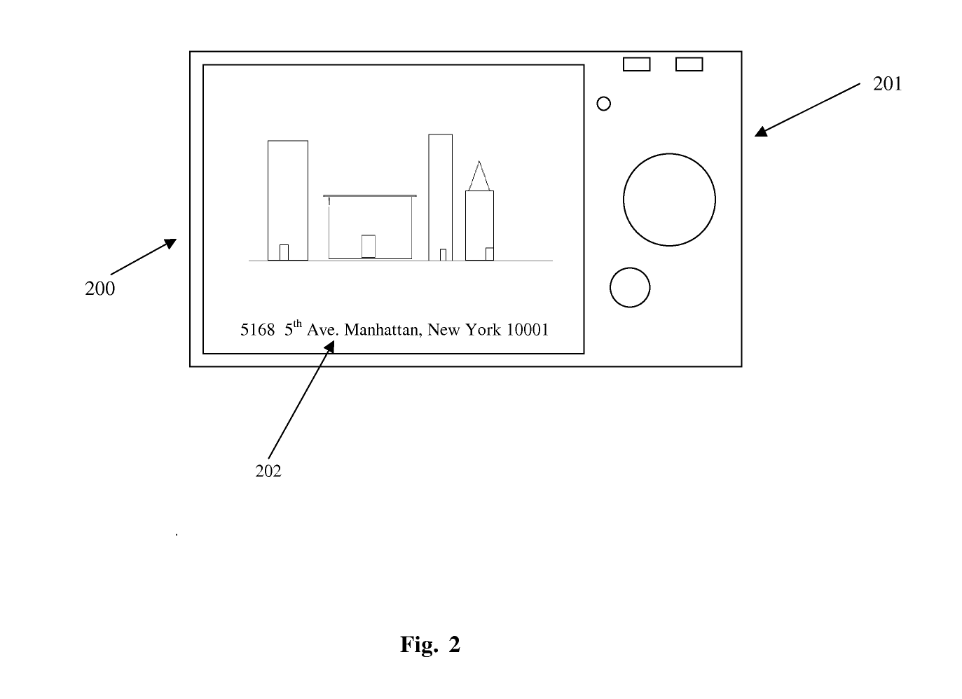

FIG. 2: A drawing to show said automated location information input system for camera is activated and displaying location information on said camera.

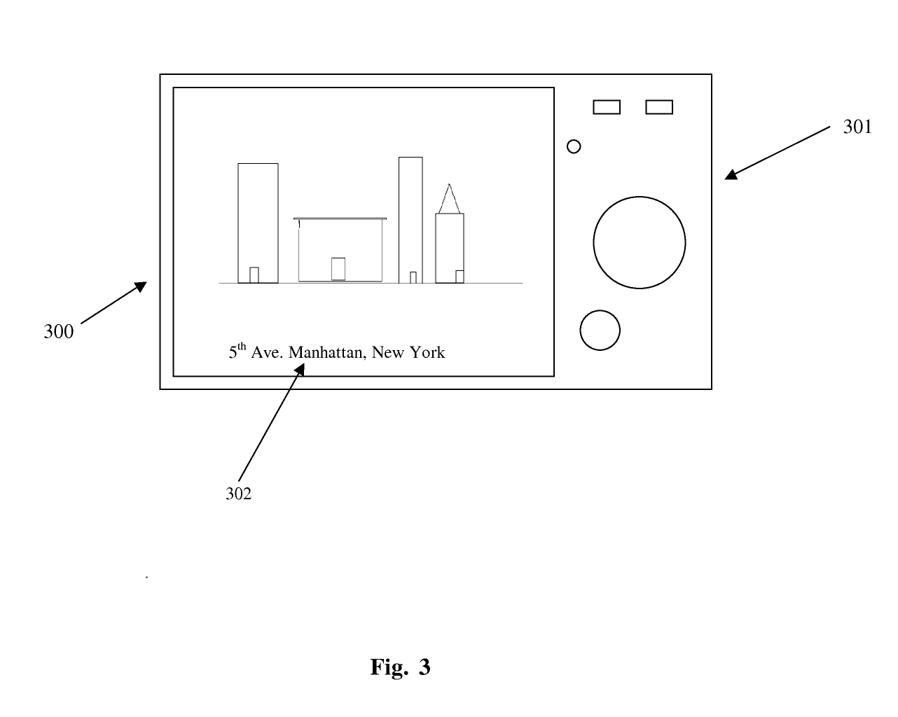

FIG. 3: A drawing to show that location information received and displayed on LCD viewfinder of said camera is modified by a user, and the finalized location information is available for photograph imaging means of said camera.

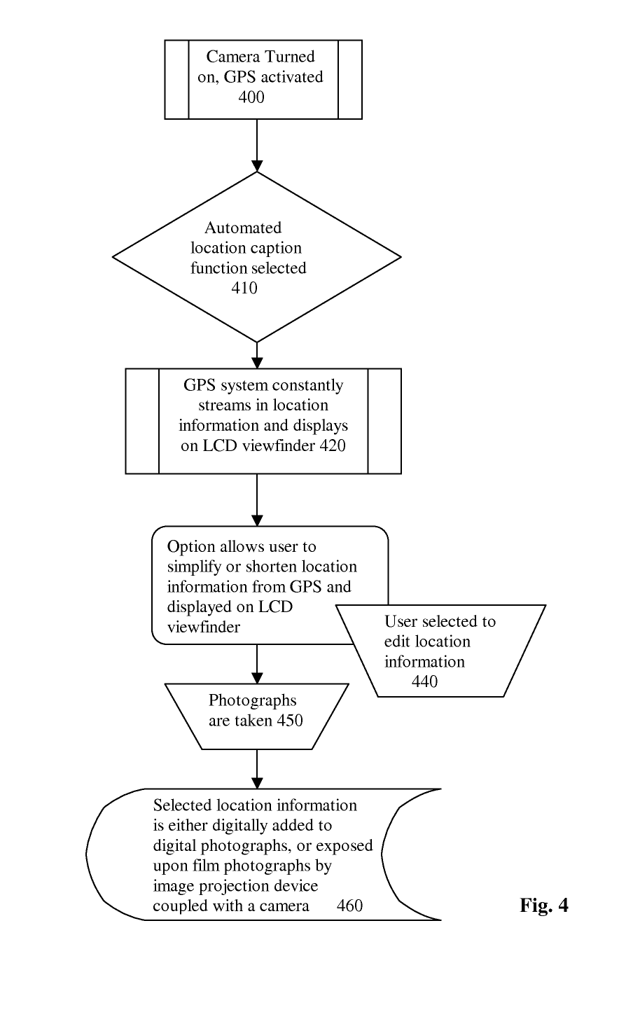

FIG. 4: A flowing chart illustrates sequential steps that said automated location information input system for camera receives and displays location information and adds location information on photographs when they are taken.

### PREFERRED EMBODIMENTS

Referencing to drawings, in FIG. 1 a camera (FIG. 1-100) of a preferred embodiment, a microprocessor to a GPS and installed in said camera (FIG. 1-101), said microprocessor receives location data from said GPS. A menu option of “Turn on Automated Location Caption” is shown on said LCD viewfinder with touch screen function (FIG. 1-102). Said user presses “Yes” button or says “Yes” to a microphone (FIG. 1-103) to activate automated location information input system for said camera.

Referring to FIG. 2 and FIG. 3 once said automated camera location information input system coupled to said camera (FIG. 2-200) is turned on, location information received from GSP is processed by said microprocessor and displayed on said LCD viewfinder (FIG. 2-202). Said user may accept location information received from said GSP, or editing or altering said location information by using text editing function on said LCD viewfinder (FIG. 3-300) and modified location information is displayed on said LCD (FIG. 3-302). Said location information displayed is shared with digital imaging means of said camera, and is ready to be digitally added on and saved on a digital photograph or to be exposed to a film by an imprint projection device coupled to said microprocessor. Said data-receiving device continue to update, and once said user leaves said location range, said location information displayed on said viewfinder of said camera will be updated with another location information, and subsequently newly updated location information is ready to be shared with photograph imaging means of said camera and added on photographs when they taken. Said user may cancel the option(s) at anytime.

Referring to FIG. 4 a flowchart illustrates logical flows of said embodiment of said automated location information input system for camera. Said camera is turned and GPS is activated as while (FIG. 4-400). Said user selected to add location information on photographs by responding to a menu option by either pressing option on the touch screen or giving verbal command through a microphone (FIG. 4-410). Said microprocessor constantly receives location information from said GPS coupled to it, and displays said information on LCD viewfinder of said camera (FIG. 4-420). Said user may decide to keep the original location information from GPS or wish to modify them (FIG. 4-430, FIG. 4-440). Edited location information is ready to be shared with photograph imaging means of said camera and added on photographs. Photographs are taken (FIG. 4-450) and said location information is added to photographs via photograph imaging means of said camera and said photographs are saved and stored in photographs storing means of said camera (FIG. 4-460).

The embodiment is mainly an illustration on the invention, advantages of the invention will be set forth in part in the description which follows, and in part will be obvious from the description, or may be learned by practice of the invention. The advantages of the invention will be realized and attained by means of the elements and combinations particularly pointed out in the claims. Further it is to be understood that both the foregoing general description and detailed description are exemplary and explanatory only and are not limited to the invention as claimed.

It claims:

1. An automated location information input system for camera comprising:
a. a microprocessor coupled to a GPS (Global Position System), or to a GIS (Geographical Information System) via a network and or internet connection, said microprocessor receiving and processing location information from said GPS or said GIS;
b. a display means such as a LCD touch screen viewfinder coupled to said microprocessor and capable of displaying said location information processed by said microprocessor;
c. said microprocessor capable of processing information edited by a user via a graphic user interface (GUI) function of said display means or a keyboard;
d. said microprocessor coupled to a photograph imaging means, and capable of transferring said location information to said photograph imaging means, and adding said location information to photographs when they are taken and further stored in a photographic storing means.

2. The automated location information input system for camera of claim 1 wherein said microprocessor is capable of continuously receiving and updating location information from said GPS or said GIS via a network and or internet connection.

3. The automated location information input system for camera of claim 2 wherein said updated location information is instantly displayed on said display means, and further simultaneously available to said photograph imaging means.

4. The automated location information input system for camera of claim 1 wherein said microprocessor is capable of allowing a user to select said location information written to a single picture or multiple photographs.

5. The automated location information input system for camera of claim 2 wherein said microprocessor is capable of allowing a user to select and or edit location information displayed on said display means with a touch screen function or said keyboard.

6. The automated location information input system for camera of claim 1 wherein said microprocessor is capable of receiving and process different languages.

7. The automated location information input system for camera of claim 1 wherein said microprocessor is capable of coupling to a photo and or video camera, a cell phone and or a personal digital assistant (PDA) installed with photo and or video camera functions.

8. The automated location information input system for camera of claim 1 wherein said system is capable of being activated and deactivated by a menu selection displayed on said display means, or through a verbal command via a voice command device coupled to a microphone.

9. A method for location information input system for camera comprising the steps of: a microprocessor constantly receiving and updating location information from a GPS or a GIS; displaying said location information on a display means; receiving user information, the user information, including edited information received via a GUI function of said display means from said user; sharing location information with a photograph imaging means for addition to photographs when they are taken; storing said photographs in a photographic storing means; and showing said location information on said photographs when said photographs are digitally displayed or physically printed on a photographical paper or any other means of photographic printing media.
